(19) United States
(12) Patent Application Publication
(10) Pub. No.: US 2015/0322230 A1
(43) Pub. Date: Nov. 12, 2015

(54) MOLDED PARTS MADE OF CARRIER MATERIALS WHICH CONTAIN FOAMING REACTIVE RESIN

(71) Applicant: BASF SE, Ludwigshafen (DE)

(72) Inventors: Dietrich SCHERZER, Neustadt (DE); Frank PRISSOK, Lemforde (DE); Markus SCHUTTE, Osnabruck (DE); Armin ALTEHELD, Bad Kreuznach (DE); Jurgen MERTES, Ludwigshafen (DE); Klaus HAHN, Kirchheim (DE); Hans-Jürgen QUADBECK-SEEGER, Bad Durkheim (DE)

(21) Appl. No.: 14/801,938

(22) Filed: Jul. 17, 2015

Related U.S. Application Data
(62) Division of application No. 12/809,420, filed on Jun. 18, 2010.

(51) Int. Cl. C08J 9/40; B29C 44/12

(52) U.S. Cl. CPC C08J 9/405; B29C 44/12; C08J 2361/28; C08J 2475/08; C08J 2205/10; B29K 2033/04

(57) ABSTRACT

The invention provides a molding producible by a process comprising the following steps:
a) introduction of a foamable reactive resin into a support material and
b) compressive deformation of the support material comprising the foamable reactive resin.

### CROSS REFERENCE TO RELATED APPLICATIONS

This application is a divisional of U.S. Ser. No. 12/809,420, filed Jun. 18, 2010, which is a national stage application under 35 U.S.C. §371 of PCT/EP2008/068010, filed Dec. 19, 2008, and which claims benefit to European application 07150121.7, filed Dec. 19, 2007, the entire disclosures of which are hereby incorporated by reference.

### BACKGROUND OF THE INVENTION

1. Field of the Invention

The present invention relates to a molding producible from support materials comprising foamable reactive resin, these materials being subjected to a compressive deformation step, and also to a production process for such moldings. The present invention further relates to panels comprising such moldings, and to the use of these moldings and/or of the panels in vehicle construction, including aircraft construction, or as a fire protection layer.

2. Description of Related Art

DE-A 196 40 887 relates to a flat fire protection material having at least one layer I of hydrous, fiber-reinforced sodium silicate and at least one layer II of a flexible open-celled foam, more particularly of a melamine/formaldehyde resin. In the production of the fire protection material the layers I and II are arranged separately from one another; the fire protection material may also comprise two or more layers I and II in alternation. The fire protection material is typically enveloped with an epoxy resin covering and laminated with a protective layer, such as, for example, with an aluminum foil or with a film of polyester, polyethylene or polyvinyl chloride or with a sheet of paper. DE-A 196 40 887, however, does not disclose the introduction of foamable reactive resin into the flexible open-celled foam and its subsequent subjection to a compressive deformation step.

DE-A 42 11 762 discloses foam profiles of low or no combustibility which are intended for the fire protection sealing of construction apertures such as joints, passages through walls or interspaces between components, for example. In its cavities and/or over all of its surfaces, the foam profile comprises substances that are intumescent in the event of a fire and form an insulating layer, such as expandable graphite, silicates or polyurethanes (PUs).

The foam material used is, for example, a melamine resin foam. The substances that form an insulating layer may further comprise polyvinyl acetate dispersions in the case of nitrogenous expandants and latex dispersions in the case of aqueous alkali metal silicates. The foam profiles are produced by impregnating the foams and/or coating them on all sides with the intumescent substances that form an insulating layer. Impregnation may be carried out, for example, by immersion of the foams into a solution or dispersion of the substance that forms an insulating layer, preferably with the aid of dip rolls or squeeze rolls, followed by squeezing-off to remove the excess solution or dispersion, and subsequent drying. The degree of impregnation can be varied by varying the roll pressure. DE-A 42 11 762 does not, however, describe any compressive deformation step of the support material comprising foamable reactive resin. After the curing procedure, this process yields materials which in principle are brittle and hard. The foam profiles described therein are not suitable as lightweight moldings for use in vehicle construction.

WO 2005/095728 relates to an exterior insulation and finishing system comprising two metal sheets with a thermally insulating core material, a fire protection layer with an intumescent composition having been introduced between the thermally insulating core material and at least one of the metal sheets. The fire protection layer used may be, for example, a thermally resistant melamine resin foam (such as Basotect®) or a fire protection laminate comprising gelled alkali metal silicate solution (such as Palusol®). The latter are also identified as intumescent compositions, and may additionally comprise adhesives based on polyurethane resins or epoxy resins and also dispersion-based resins, such as acrylate dispersions, for example. Furthermore, additives such as expandable graphite or melamine compounds may be added to the fire protection layer, in other words to the melamine resin foam or to the intumescent composition. Nowhere, however, does WO 2005/095 728 disclose the introduction of the adhesives based on polyurethane or epoxy resins into the support material (melamine resin foam) and its subsequent subjection to a compressive deformation step.

EP-A 0 672 524 relates to a method of producing dimensionally stable acoustic components by laminating both sides of boards composed of an open-celled thermoset foam, a melamine/formaldehyde resin, for example, with thin outer layers of high tensile strength. A binder in the form of an aqueous suspension is applied to the surface of the foam boards, the outer layer is placed thereon, and the assembly is subjected to compression at temperatures between 50 and 250° C. and pressures of 2 to 200 bar. Suitable binders include curable condensation resins such as melamine resins, urea resins, and phenolic resins, which are used in the form of an approximately 50%, aqueous suspension.

In a DE European patent application by the applicant, with the number 07 120 027.3, a layer (A) is disclosed which comprises at least one support material, at least one compound such as intumescent compositions or silicate compounds, and at least one polymer preparable from at least one vinylaromatic monomer. This layer may be applied to a core and is suitable, for example, as an adhesive layer or as a combustion prevention layer, and also for improving the flame resistance in a sandwich panel. Moreover, this layer may be part of an exterior insulation and finishing system which additionally comprises one or two outer layers. In this layer (A), besides the aforementioned components, there may also be adhesives based on polyurethane or epoxide. That application, however, does not disclose the subjection of the layer it describes to a compressive deformation step, does not discloses that the adhesives are foamable reactive resins, and does not disclose that the reactive resin is introduced into the support material in the absence of water if appropriate.

Made of plastics such as polypropylene or polycarbonate or of aramid fiber (Nomex paper), honeycomb materials are materials uniting high mechanical strength with comparatively low weight, and are used more particularly in the aerospace industry in tail units or wings (see Internet extract from the German “Wikipedia” (www.de.wikipedia.org in the entries for “Wabe”, “Honeycomb” and “Aramid”)). Aramids, or aromatic polyamides (polyaramids), are long-chain synthetic polyamides in which, according to a definition from the U.S. Federal Trade Commission, at least 85% of the amide groups are attached directly to two aromatic rings. Aramid fibers are marketed under the brand names “Nomex” or “Kevlar”.

### BRIEF SUMMARY OF THE INVENTION

The problem addressed by the present invention is that of providing new moldings which on the one hand are light in weight but on the other hand are also stable and can be used as lightweight components in vehicle construction, more particularly in aircraft and railroad applications. This problem is solved by a molding producible by a process comprising the following steps:
a) introduction of a foamable reactive resin into a support material and
b) compressive deformation of the support material comprising the foamable reactive resin.

### DETAILED DESCRIPTION OF THE INVENTION

It is an advantage of the present invention that the moldings can be produced in a process which can be automated, and possess improved mechanical properties. Hence the moldings of the invention feature good flexural strength and tensile strength and also a high and stable deformability. Moreover, their density is low, their weight is light, and their combustibility is low, and hence they can also be used as a fire protection layer. Of particular advantage are moldings in which the foamable reactive resin is distributed in the form of a gradient in the support material. In that case, for example, the interior of the support material (core) is extremely light (comprising less foamable reactive resin), while the edge of the support material is heavier than the core (comprising more foamable reactive resin). An alternative option is to set a reactive resin gradient where the support material comprises very little or no foamable reactive resin on one of its flat sides, and a very high concentration of foamable reactive resin on its opposite side. The reason for the particular advantage of the moldings of the invention is that, by virtue of the process of the invention, they can easily take on any desired form and that form at the same time is very stable.

The text below gives a more detailed definition of the moldings of the invention and of the process for producing the moldings of the invention. The moldings are preferably flat moldings, in other words moldings in which the third dimension (thickness) is smaller than the first (length) and second (width) dimensions. Not only the moldings but also the process for producing the moldings are subject matter of the present invention. The moldings of the invention are producible by a process comprising the following steps:
a) Introduction of a foamable reactive resin into a support material

In step a) support materials are produced that comprise the foamable reactive resin and that are also referred to as hybrid foams. If appropriate it is also possible for two or more different foamable reactive resins to be introduced into the support material.

Suitability as support materials is possessed in principle by all of the flat materials that are known to the skilled worker and can be used as a support, matrix or framework. Support materials preferably possess high absorbency. They can in principle be disposed in any desired forms or thicknesses. Preferably the flat support material is of a board format, the third dimension (thickness) being smaller than the first (length) and second (width) dimensions of the flat support material. The length and the width of the flat support material may be the same or different. The thickness of the support material is dependent generally on the nature of the material used, and is normally between 0.1 and 50 mm, preferably between 1 and 20 mm.

Preferred support materials are selected from an open-celled foam, woven materials, fibers, cotton fabric, glass wool, mineral wool, paperboard, corrugated paperboard, melamine resin fibers or other foams.

More preference is given to using an open-celled foam as support material. Suitable open-celled foams are melamine resin foam (available commercially, for example, under the name Basotect®), PIA (polyisocyanurate), polyimide foams or foams based on inorganic materials, examples being aluminum phosphates, silicates, carbonized foams or ceramized foams. Particular preference is given to melamine resin foam. Melamine resin foams and the processes for preparing them are described in WO 01/94436, for example.

One embodiment of the present invention uses as support material an open-celled foam having a density of ≦25 g/l and/or a pore size between 10 μm and 1000 μm, preferably between 50 μm and 300 μm. In this embodiment the open-celled foam is preferably a melamine resin foam.

Suitable for use as foamable reactive resin are in principle all those reactive resins known to the skilled worker that possess foamability properties. The foamable reactive resin is preferably selected from at least one (foamable) polyurethane resin (PU resin), (foamable) polyester resin or (foamable) epoxy resin. More particularly the foamable reactive resin. is a polyurethane resin. Suitable polyurethane resins, polyester resins or epoxy resins are known to the skilled worker. Such resins are disclosed in, for example, Rompp online, Version 3.0 (Georg Thieme Verlag; 2007) in the entries on (unsaturated) polyester resins, polyurethane resins, polyurethanes or epoxy resins.

By polyurethane resins are meant, for the purposes of the present invention, more particularly resins based on polyurethane. They are obtained predominantly from air-drying oils (triglycerides, unsaturated fatty acids) which are first transesterified with glycerol to give a mixture of monoglycerides and diglycerides. The resulting products are then reacted with diisocyanates, preferably diisocyanatotoluenes, with an amount-of-substance ratio of isocyanate to hydroxyl groups 1:1, to give polyurethanes which no longer contain any isocyanate groups and which, in a manner similar to that of alkyd resins, dry and cure through air oxidation. They can alternatively be prepared from diisocyanates and polyalcohols (glycerol, pentaerythritol) partially esterified with unsaturated acids (e.g., with tall oil).

By polyester resins are meant, for the purposes of the present invention, preferably unsaturated polyester resins. More particularly the polyester resins are reactive resins based on unsaturated polyesters prepared from unsaturated dicarboxylic acids, such as maleic acid or fumaric acid, and primarily dihydric alcohols, such as ethylene glycol and propane-1,2-diol, which in the course of the application undergo curing with polymerization and crosslinking to form thermoset compositions. In the course of their preparation use may be made, as additional components, of copolymerizable monomers (styrene, α-methylstyrene, vinyltoluene, methyl methacrylate, etc.) as solvents or diluents, of bifunctional monomers (e.g., divinylbenzene, diallyl phthalate) as crosslinkera and curatives (polymerization initiators, e.g., peroxides), accelerants, pigments, plasticizers, antistats, fillers, and reinforcing agents (organic- or inorganic-based fibers).

By epoxy resins are meant, for the purposes of the present invention, preferably not only oligomeric compounds having more than one epoxide group per molecule, which can be used to produce thermosets, but also the corresponding thermosets themselves. The conversion of the epoxy resins into thermosets is accomplished via polyaddition reactions with suitable curatives and/or by polymerization via the epoxide groups. Epoxy resins are preferably prepared through reaction of bisphenol A (aromatic dihydroxy compounds) with epichlorohydrin in an alkaline medium to form chainlike compounds.

The foamable reactive resins used in the context of the present invention generally display their foaming action when they are introduced into the support material, more particularly after at least one step of roll incorporation. A feature of the foamable reactive resins is that they are curable more quickly and/or at lower temperatures than other resins. Preferably the foamable reactive resins are curable at a temperature <150° C., more particularly <100° C., and/or a timespan ≦5 min, more particularly ≦1 min. Curable condensation resins of the kind disclosed in EP-A 0 672 524, for example, cannot be cured as quickly and/or have to be cured at higher temperatures.

The curable condensation resins described in EP-A 0 672 524, melamine resins, urea resins, and phenolic resins, for example, which are used as binders, do not come under the definition of foamable reactive resins in accordance with the present invention.

The foamable reactive resin may be introduced into the support material by any of the methods that are known to the skilled worker as for example by impregnating the support material with foamable reactive resin. Alternatively (the surface of) the support material may also be sprayed with foamable reactive resin. Normally the foamable reactive resin is applied with maximum uniformity, the amount of foamable reactive resin used (volume in ml) corresponding approximately to 1-10 times the amount of the support material in grams. The process of the invention can be carried out by immersing the support material fully into the impregnating solution comprising the foamable reactive resin, or only one flat side of the support material is immersed. Subsequently, if appropriate, the opposite side of the support material can be immersed likewise into the same or a different impregnating solution. This method can be used, for example, to set the reactive resin gradients described below. If appropriate the impregnating steps (introduction) can be repeated. The same applies, mutatis mutandis, to the spraying or to other methods of introducing the foamable reactive resin into the support material.

In one embodiment of the present invention the foamable reactive resin, more particularly polyurethane resin, is prepared directly before step a) is carried out. In that case, using methods that are known to the skilled worker, the foamable reactive resin is prepared by mixing the (two) liquid reactants, and preferably a blowing agent is added. Where a polyurethane resin is being used, the blowing agent may also be water. Directly thereafter the foamable reactive resin is introduced into the support material: for example, by spray application to the support material and, if appropriate, subsequent roller or roll incorporation into the support material. Alternatively the foamable reactive resin can be prepared from the respective reactants actually in the support material. In that embodiment, therefore, it is the reactive resin reactants, rather than the ready-prepared reactive resin, that are introduced into the support material.

In one embodiment of the present invention step a) is carried out in the absence of water. By absence of water is meant, for the purposes of the present invention, that, based on the amount of foamable reactive resin used, not more than 2%, preferably not more than 0.5%, and more particularly not more than 0.1% by weight of we3:ter may be contained within the product obtained in step a). This residual water may be present in the respective reactants, for example, on account of their preparation processes. This embodiment can be employed preferably when the foamable reactive resin is selected from at least one polyester resin or epoxy resin.

Following the introduction (by impregnating or spraying, for example) of the foamable reactive resin into the support material, it is preferred to carry out one or more deformation steps, the reactive resin being roll-incorporated into the support material through the use of a suitable tool (a roll, for example). These steps can if appropriate be repeated a number of times, as for example by multiple impregnation in alternate order with multiple rolling steps, including steps with different severities and/or durations, for example. The rolling may have the effect, for example, of removing excess foamable reactive resin until the desired amount of foamable reactive resin is present in the support material. In step a) the products are preferably hybrid foams (support material comprising reactive resin) having overall densities (OD) of 20 to 400 g/l. If appropriate it is also possible to produce higher overall densities.

The properties of the hybrid foam produced in this process are a product of the foamable reactive resin used (polyurethane system, for example) and the overall density that is set.

In one preferred embodiment of the present invention the foamable reactive resin takes the form of a gradient in the support material. In this case there is less foamable reactive resin in the interior of the support material than at the edge of the (flat) support material. Consequently the interior of the support material (core) is lighter in weight than the edges of the support material. Gradients of this kind can be set, for example, by multiple repetition of step a), more particularly by multiple impregnation and, if appropriate, multiple rolling. An alternative option is to set a reactive resin gradient where the support material comprises very little or no foamable reactive resin on one flat side and a very high concentration of foamable reactive resin on the opposite side of the support material.

The hybrid foam may further comprise, additionally, additives. Examples of suitable additives include flame retardants such as intumescent compositions, alkali metal silicates, melamine, melamine polyphosphate, melamine cyanurate, aluminum hydroxide, magnesium hydroxide, ammonium polyphosphates, organic phosphates or else flame-retardant halogen compounds. Likewise suitable as additives are plasticizers, nucleators, IA absorbers such as carbon black and graphite, aluminum oxide powder or Al(OH)₃, soluble and insoluble dyes, substances with biocide activity (such as fungicides), and pigments.

The hybrid foam may if appropriate also be reinforced with further organic or inorganic particles. The best way of introducing such particles is in the form of a blend with the foamable reactive resin. Examples of suitable reinforcing fillers are as follows: short glass fibers, talc, chalk or other minerals, nanotubes, phyllosilicates or carbon fibers.
b) Compressive deformation of the support material comprising the foamable reactive resin (hybrid foam)

The term “compressive deformation* or “compressive deformation step” (step b)) refers, for the purposes of the present invention, to the treatment of the support material comprising the foamable reactive resin (hybrid foam) at elevated pressure and elevated temperature. A suitable mold is used that is known to the skilled worker and is preferably heatable, its shape determining the shaping of the molding to be produced. It is possible, here, for example, to use what are called inserts or molds having specially shaped surfaces to produce workpieces (moldings) with a wide variety of different appearances and/or thicknesses.

By elevated pressure is meant any pressure greater than atmospheric pressure (1 bar). In accordance with the invention step b) is normally carried out by inserting the support material obtained in step a), that comprises the foamable reactive resin, into a suitable mold, and then applying pressure. In one preferred embodiment of the present invention the compressive deformation step is carried out at elevated temperature. In this preferred embodiment step b) is also referred to as a thermoforming step. The principle here is that the higher the temperature used in step b), the lower the residence time in the mold of the support material comprising the foamable reactive resin.

Preferably step b) is carried out at a temperature of 50 to 200° C. and/or a pressure of 2 to 200 bar. Depending on the system used, the completed molding may be removed after several minutes, such as after 0.5 to 2 minutes, for example. If appropriate the compressive deformation step may also be carried out over a longer period.

The physical properties of the moldings obtained are dependent on the degree of compression, on the support material used, on the foamable reactive resin used, and on the fraction of the reactive resin in the support material. Moldings with a virtually unlimited spectrum of properties can be produced.

As a result of the compressive deformation step the thickness of the completed flat molding is normally less than or, at most, equal to the thickness of the support material used in step a). The molding after pressure deformation (step b)) preferably has a thickness of ≦80% in comparison to the thickness of the support material used in step a). In one embodiment of the present invention the thickness of the completed molding may be reduced to 10% to 50% of the thickness of the support material used in step a).

Prior to or following step b), preferably prior to step b), it is possible in one embodiment of the present invention to apply an outer layer to at least one (flat) side of the support material comprising foamable reactive resin. Where the outer layer is applied prior to step b), it is applied to one or more (flat) sides (surfaces) of the support material comprising the foamable reactive resin (hybrid foam). Where the outer layer is applied after step b), it is applied to one side (surface) of the completed molding. It is preferred to apply an outer layer to each of the two opposite (flat) sides of the support material comprising the foamable reactive resin. In that case the materials in question may be either identical materials or different materials. If appropriate it is possible to apply two or more outer layers to at least one side or to two opposite sides of the hybrid foam or complete molding. A molding of the invention which has an outer layer on at least one side (surface) of the support material comprising the foamable reactive resin is referred to as a panel. Where there is an outer layer on two opposite sides of the support material comprising the foamable reactive resin, the term sandwich panel is used.

Suitability as outer layer is possessed in principle by all of the outer layers that are known to the skilled worker. Preferably the outer layer is composed wholly or at least partly of metal, more particularly aluminum, wood, insulating material, plastics, in the form for example of polymeric films or plastic sheets, corrugated metal sheet, other metal sheets, glass fiber wovens, glass fiber mats, plaster or chipboard. Where an outer layer of wood is used, it is preferably of wood veneer; outer layers of plastic also comprise polyurethane foams. With greater preference the outer layer is of aluminum, metal sheets, glass fiber wovens, polymeric films, plastic sheets or wood veneer, with particular preference of aluminum. The outer layer is preferably a foil/film, a glass fiber mat, or both.

The outer layer is preferably applied to the support material comprising the foamable reactive resin after the material has been rolled out. The thickness of the outer layer is preferably less than the thickness of the support material, preferably less by a factor of at least 10. Examples of suitable outer layers are an aluminum foil 0.1 mm thick. Preferably, in the subsequent step b), the molding comprising at least one outer layer is compressed to ≦80% of the initial thickness of the support material. Adhesion between hybrid foam and outer layer normally results from the foamable reactive resin that exudes from the foam in the course of compression. In one embodiment of the present invention the foamable reactive resin is introduced (by impregnation or spraying, for example) only on one flat side of the support material in step a). In this way a gradient is formed, with a greater concentration of foamable reactive resin on the side (surface) of the support material where the reactive resin was introduced. The reactive resin concentration in the core of the support material is lower, while on the opposite (flat) side of the support material there is no foamable reactive resin. In this way it is simple to produce panels which are provided with an outer layer on only one flat side of the support material comprising the reactive resin, said layer being, for example, a glass fiber mat, insulating material, wood, metal or polyurethane foam.

The present invention further provides a panel comprising at least one molding of the invention producible by a process in accordance with the above description. For the purposes of the present invention the term “panel” refers more particularly to those articles which have a molding (core) and applied atop said molding, on at least one (flat) side, an outer layer. Panels may be straight (unbowed) or may have one (or, if appropriate, two or more points of) curvature (bowed). Furthermore, panels may also be textured. The panel is preferably a sandwich panel, in which an outer layer has been applied to two opposite (flat) sides of the molding. Suitable outer layers have already been set out above. The two outer layers may if appropriate be of different materials, but are preferably of the same materials. More particularly the two outer layers are selected from aluminum, metal sheets, glass fiber wovens, glass fiber mats, polymeric films, plastic sheets or wood veneer.

The present invention further provides a process for producing such panels comprising at least one molding of the invention. The process for producing the panels corresponds in principle to the above-described process for producing the moldings of the invention.

In the course of the deformation and curing of the moldings, not only is a frictional connection produced between outer layers and foam core, but the outer layers can also be deformed in unison with the foam core.

The present invention further provides for the use of the (flat) moldings of the invention in vehicle construction or else as a fire protection layer. The moldings of the invention are preferably used in vehicle construction, more particularly in aircraft or railroad applications. The reason for the particular advantage when using the moldings of the invention in vehicle construction is that on account of the production process, more particularly as a result of the thermoforming step b), they can be deformed in a simple way to give any desired shapes. These shapes, in turn, are very stable and possess outstanding mechanical properties and low combustibility. The present invention additionally provides for the use of a panel comprising a molding of the invention in vehicle construction, more particularly in aircraft or railroad applications, or as a fire protection layer.

The purpose of the examples below is to illustrate the present invention.

### EXAMPLES

### Example 1

A Basotect foam board approximately 10 mm thick (density: 10 g/l, area: 1 m²) is impregnated on both sides with a rigid polyurethane foam system (Elastopor H), free density: 30 g/l, start time: 30 sec, rise time: 120 sec, and the polyurethane resin is incorporated by means of a manual roller.

Reactant composition of Elastopor H (Index: 112)

| Parts | Component | Description |
|---|---|---|
| Polyol component: | | |
| 37.65 | sugar polyol | high-functionality sugar-based polyetherol, |
| | | MW: 550, F = 4 |
| 23 | sugar polyol | high-functionality sugar-based polyetherol, |
| | | MW: 500, F = 4.3 |
| 2 | glycerol | triol |
| 30 | difunctional poly- | propylene glycol-based polyetherol, |
| | etherol | MW: 1000, F = 2 |
| 5.4 | trifunctional poly- | propylene glycol-based polyether polyol, |
| | etherol | MW: 1000, F = 3 |
| 4.445 | foam stabilizer | modified polysiloxane |
| | blowing additive | blowing additive |
| 0.6 | cat mixture | cat mixture |
| Isocyanate component:: | | |
| 100 | Lupranat M 50 | PMDI (polymeric methylenediphenylene |
| | (manufacturer: | diisocyanate) |
| | BASF) | |

The table below sets out the amount of polyurethane resin incorporated and the resultant hybrid foam density.

| | Polyurethane resin | Volume of | Density of the |
|---|---|---|---|
| Polyurethane | fraction in the foam | the Basotect | completed hybrid |
| resin/side [g] | matrix, total [g] | foam [liter] | foam [g/l] |
| 500 | 1000 | 10 | 110 |
| 250 | 500 | 10 | 65 |
| 150 | 300 | 10 | 39 |

The boards thus impregnated are introduced into a heated mold (100° C., height: 8 mm) with an insert (height: 4 mm). After a demolding time of 2 minutes, a graduated board with thicknesses of 8 and 4 mm and with high rigidity is obtained which, depending on the amount of polyurethane resin incorporated and on the degree of compression, has an overall density varying between 39 and 300 g/l.

| | | Density of | Density of |
|---|---|---|---|
| Polyurethane resin | Density of | the hybrid | the hybrid |
| fraction in the foam | the hybrid | foam compressed | foam compressed |
| matrix [g/l] | foam [g/l] | to 8 mm [g/l] | to 4 mm [g/l] |
| 100 | 110 | 140 | 280 |
| 50 | 65 | 80 | 160 |
| 30 | 39 | 50 | 100 |

The board is dimensionally stable at temperatures of up to 180° C. and is also stable toward hydrolytic exposure. In the fire test the board attains fire class B2 (the pure polyurethane foam is fire class B3).

### Example 2

In a second test, carried out in otherwise the same way, a glass fiber mat is inserted into the mold. A molding is produced which has a glass fiber mat attached firmly to its smooth side. Application of a Bunsen burner flame to the outer glass fiber layer fails to ignite the molding.

### Example 3

Example 3 is carried out in the same way as for example 1. It uses 1000 g of a polyurethane shoe foam system. The graduated board obtained, however, has a volume weight of 200 g/l and in the fire test gives a result analogous with that for example 1.

Reactant composition of the low-density PU shoe foam system (Index: 98)

| Parts | Component | Description |
|---|---|---|
| Polyol component: | | |
| 55.23 | trifunctional polyetherol | polyetherol, MW: 5000, F = 2.5 |
| 8.7 | MEG (monoethylene glycol) | short-chain diol |
| 29.59 | graft polyol | graft polyol, 50% solids content |
| 2 | cat mixture | cat mixture |
| 1.1 | blowing agent | blowing |
| | | agent |
| 3 | urea | additive for increasing hardness |
| Isocyanate component: | | |
| 100 | Iso 137/28 | prepolymer based on MDI |
| | | (methylenediphenylene |
| | | diisocyanate) |

### Example 4

Example 4 is carried out in the same way as for example 1. It uses 2000 g of a polyurethane elastomer system. The graduated board obtained, however, has a volume weight of 400 g/l and in the fire test gives a result analogous with that for example 1.

Reactant composition of the low-density PU elastomer system (Index: 105)

| Parts | Component | Description |
|---|---|---|
| Polyol Component: | | |
| 66.47 | trifunctional polyetherol | polyetherol, MW: 5000, F = 2.5 |
| 15 | trifunctional polyetherol | polyetherol MW: 200, F = 3 |
| 13 | DPG (dipropylene glycol) | branched diol |
| 5 | 1,4-butanediol | diol (chain extender) |
| 0.5 | foam stabilizer | silicone-based stabilizer |
| 0.015 | Lupragen N 201 | amine catalyst |
| Isocyanate component: | | |
| 100 | Lupranat M 20 | PMDI |

What is claimed is:

1. A process for producing a molding, the process comprising the following steps:
a) introduction of a foamable reactive resin into a melamine resin foam support material wherein the foamable reactive resin displays its foaming action when it is introduced into the support material, wherein the foamable reactive resin is at least one polyurethane resin, polyester resin or epoxy resin, and
b) compressive deformation of the melamine resin foam support material comprising the foamable reactive resin, wherein at elevated pressure and elevated temperature, a suitable mold is used and wherein the molding after compressive deformation (step b)) has a thickness of ≦80% in comparison to the thickness of the support material used in step a).

2. The process according to claim 1, wherein an outer layer is applied to at least one side of the melamine resin foam support material comprising the foamable reactive resin before step b) is carried out.

3. The process according to claim 1, wherein the melamine resin foam support material comprising the foamable reactive resin has an overall density of 20 to 1000 g/l.

4. The process according to claim 1, wherein the foamable reactive resin is distributed in the form of a gradient in the melamine resin foam support material.

5. The process according to claim 1, wherein step b) is carried out at a temperature of 50 to 200° C. or a pressure of 2 to 200 bar.

6. The process according to claim 2, wherein the outer layer is of metal, wood, insulating material, plastics, corrugated metal sheet, other metal sheets, glass fiber wovens, glass fiber mats, plaster or chipboard.

7. The process according to claim 6, wherein the metal is aluminum.
